(19) United States
(12) Patent Application Publication
(10) Pub. No.: US 2023/0213005 A1
(43) Pub. Date: Jul. 6, 2023

(54) EMISSION CONTROL SYSTEM AND VEHICLE-MOUNTED SOLID OXIDE FUEL CELL SYSTEM

(71) Applicants: Ceres Intellectual Property Company Limited, Horsham, West Sussex (GB); WEICHAI POWER CO., LTD., Weifang, Shandong (CN)

(72) Inventors: Hongmin Cao, Weifang, Shandong (CN); Xuesong Shen, Weifang, Shandong (CN); Chunlei Gao, Weifang, Shandong (CN)

(21) Appl. No.: 18/009,609

(22) PCT Filed: Jun. 29, 2021
(86) PCT No.: PCT/CN2021/103046

§ 371 Date: Dec. 9, 2022

(30) Foreign Application Priority Data
Jun. 30, 2020 (CN) 202021257915.8

(51) Int. Cl. F02M 26/04; H01M 8/04014; F01N 3/02; F02M 26/51

(52) U.S. Cl. CPC F02M 26/04; H01M 8/04022; F01N 3/02; F02M 26/51; H01M 2250/20; H01M 2008/1293

(57) ABSTRACT

The invention discloses an emission control system. A vehicle-mounted solid oxide fuel cell system using the emission control system comprises a stack and a burner. The emission control system comprises an EGR intake pipe, as well as an exhaust cooling device, a supercharging device, a gas storage device and an EGR valve connected in sequence by the EGR intake pipe. An inlet end of the EGR intake pipe is connected to an exhaust pipe of the burner, and an outlet end of the EGR intake pipe is connected to an inlet pipe between the stack and the burner. This solution adds an EGR system to the original vehicle-mounted solid oxide fuel cell system. As the introduced exhaust gas can reduce the ambient temperature of the inlet gas, the generation of pollutants such as NOx can be reduced. In addition, after the EGR exhaust gas participates in combustion, the combustion temperature is further reduced, thereby inhibiting the generation of pollutants such as NOx. The present invention also discloses a vehicle-mounted solid oxide fuel cell system comprising the foregoing emission control system.

### TECHNICAL FIELD

The present invention relates to fuel cell systems, particularly to an emission control system and a vehicle-mounted solid oxide fuel cell system.

### BACKGROUND ART

Currently, electric vehicles equipped with a solid oxide fuel cell (SOFC) system are becoming a research hotspot. An SOFC system operating in a steady state has very high efficiency and very low emission of CO, NOx, and particulate matter, but during start and warm—up, the emission of pollutants such as CO and NOx can still be relatively high.

Therefore, how to reduce the pollutant emissions of the vehicle-mounted SOFC systems during start and warm-up is a technical problem that needs to be solved.

### SUMMARY OF THE INVENTION

For this reason, an object of the present invention is to provide an emission control system for use in a vehicle-mounted solid oxide fuel cell system. The emission control system can intervene in the combustion process during start and warm-up to reduce the emissions of NOx and other pollutants. Another object of the present invention is to provide a vehicle-mounted solid oxide fuel cell system comprising the emission control system.

One aspect of the invention provides an emission control system for use in a vehicle-mounted solid oxide fuel cell system. The vehicle-mounted solid oxide fuel cell system comprises a stack and a burner. The emission control system comprises an EGR (exhaust gas recirculation) intake pipe, and an exhaust cooling device, a supercharging device, a gas storage device, and an EGR valve connected in sequence by the EGR intake pipe. An inlet end of the EGR intake pipe is connected to an exhaust pipe of the burner and an outlet end of the EGR intake pipe is connected to an inlet pipe between the stack and the burner.

The emission control system can further comprise a control device used for controlling the opening degree of the EGR valve. The control device can comprise a fuel cell control unit and an opening degree actuator.

The emission control system can further comprise an inlet gas flow detector connected to the fuel cell control unit for detecting the flow of the inlet gas input from the stack into the inlet pipe. The inlet gas flow detector can comprise a fan arranged at a gas inlet of the stack, and a temperature and pressure sensor arranged at a gas outlet of the stack.

The emission control system can further comprise an exhaust gas flow detector, which is connected to the fuel cell control unit. The exhaust gas flow detector can comprise an EGR pressure stabilizing pipe connected between the gas storage device and the EGR valve, and a temperature and pressure sensor arranged on the EGR pressure stabilizing pipe.

The emission control system can further comprise a fuel metering unit used for measuring the flow of the fuel input into the burner, and a temperature sensor, and a nitrogen and oxygen sensor connected to the exhaust pipe.

The gas storage device can be a high pressure gas cylinder. The high pressure gas cylinder can be provided with a first vent valve and a second vent valve, wherein the first vent valve is arranged between the high pressure gas cylinder and the EGR valve.

Another aspect of the invention provides an emission control system. A vehicle-mounted solid oxide fuel cell system using the emission control system comprises a stack and a burner. The emission control system comprises an EGR intake pipe, an exhaust cooling device, a supercharging device, a gas storage device, and an EGR valve connected in sequence by the EGR intake pipe. An inlet end of the EGR intake pipe is connected to an exhaust pipe of the burner, and an outlet end of the EGR intake pipe is connected to an inlet pipe between the stack and the burner.

During start and warm-up, air passes through the stack and then enters the burner where the air is mixed and combusted with the fuel gas introduced from a fuel gas channel and the gas, after combustion, preheats the entire vehicle-mounted solid oxide fuel cell system. The EGR intake pipe takes in gas from the exhaust pipe behind the burner so that some exhaust gas passes the exhaust cooling device and the supercharging device in turn and then enters the gas storage device. When the level of the pollutants such as NOx in the exhaust pipe is high, the EGR valve is opened, so that some exhaust gas is led into the inlet pipe in front of the burner and is mixed and combusted with the fuel gas.

This solution adds an EGR system to the vehicle-mounted solid oxide fuel cell system. As the introduced exhaust gas can reduce the ambient temperature of the inlet gas, the generation of pollutants such as NOx can be reduced. Further, after EGR exhaust gas participates in the combustion, the combustion temperature is further reduced, thereby inhibiting the generation of pollutants such as NOx.

The present invention further provides a vehicle-mounted solid oxide fuel cell system comprising the foregoing emission control system. The beneficial effects generated by the vehicle-mounted solid oxide fuel cell system are generally similar to the beneficial effects brought about by the foregoing emission control system.

### BRIEF DESCRIPTION OF THE DRAWINGS

The drawings used in the description of the embodiments are described below. These are just some embodiments of the present invention.

FIG. 1 is a schematic view of the layout of an emission control system.

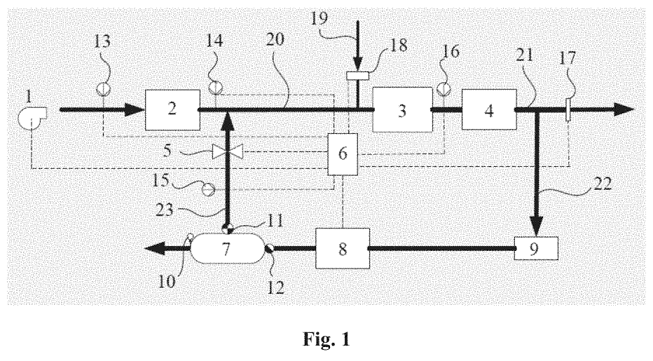

The following reference signs are used in FIG. 1:

1—fan; 2—stack; 3—burner; 4—heat exchange component; 5—EGR valve; 6—fuel cell control unit; 7—high pressure gas cylinder; 8—electric air compressor; 9—intercooler; 10—second vent valve; 11—first vent valve; 12—one-way valve; 13—first temperature and pressure sensor; 14—second temperature and pressure sensor; 15—third temperature and pressure sensor; 16—temperature sensor; 17—nitrogen and oxygen sensor; 18—fuel metering unit; 19—fuel input pipe; 20—inlet pipe; 21—exhaust pipe; 22—EGR intake pipe; 23—EGR pressure stabilizing pipe.

### DETAILED DESCRIPTION

Embodiments of the present invention will be described below in conjunction with the drawings. The described embodiments are only some of the embodiments of the present invention.

FIG. 1 is a schematic view of the layout of an emission control system in an embodiment of the present invention.

The present invention provides an emission control system for use in a vehicle-mounted solid oxide fuel cell system. The vehicle-mounted solid oxide fuel cell system comprises a stack 2 and a burner 3. The emission control system comprises an EGR intake pipe 22, as well as an exhaust cooling device, a supercharging device, a gas storage device, and an EGR valve 5 connected in sequence by the EGR intake pipe 22. An inlet end of the EGR intake pipe 22 is connected to an exhaust pipe 21 of the burner 3 and an outlet end of the EGR intake pipe 22 is connected between an inlet pipe 20 between the stack 2 and the burner 3.

During start and warm-up, air passes through the stack 2 and then enters the burner 3 where the air is mixed with the fuel gas introduced from a fuel gas channel (fuel input pipe 19 as shown in FIG. 1). The fuel gas and the air are ignited by an ignition plug and are combusted. The gas, after combustion, preheats the entire vehicle-mounted solid oxide fuel cell system. The tail gas generated after combustion in the burner 3 passes other heat exchange components 4 and then is discharged via an exhaust pipe 21. In the combustion process inside the burner 3, if the flame temperature is too high, pollutants such as NOx will be generated. This invention adopts the EGR technology in the intake process. Specifically, the EGR intake pipe 22 takes in gas from the exhaust pipe 21 behind the burner 3 so that some exhaust gas passes the exhaust cooling device and the supercharging device in turn and then enters the gas storage device. When the level of the pollutants such as NOx in the exhaust pipe 21 is high, the EGR valve 5 is opened so that some exhaust gas is led into the inlet pipe 20 in front of the burner 3 and is mixed and combusted with the fuel gas.

This solution adds an EGR system to the vehicle-mounted solid oxide fuel cell system. As the introduced exhaust gas can reduce the ambient temperature of inlet gas, the generation of pollutants such as NOx can be reduced. Further, after EGR exhaust gas participates in the combustion, the combustion temperature is further reduced, thereby inhibiting the generation of pollutants such as NOx. After the system completes start and warm-up, the EGR valve 5 is closed. The emissions of the vehicle-mounted solid oxide fuel cell system in a normal operating state do not exceed the limit.

The exhaust cooling device in the EGR system is used for cooling the high-temperature exhaust gas. An intercooler, a heat exchanger, or the like can be used. The supercharging device is used for pressurizing the exhaust gas. A gas compressor, an electric air compressor, or the like can be used. The gas storage device is used for temporarily storing pressurized exhaust gas so that the exhaust gas is input to the inlet pipe 20 at certain pressure. A gas storage tank, a high pressure gas cylinder, or the like can be used. In one embodiment, the exhaust cooling device is an intercooler 9, the supercharging device is an electric air compressor 8, and the gas storage device is a high pressure gas cylinder 7. The EGR intake pipe 22 introduces gas from the exhaust pipe 21. After being cooled in the intercooler 9, the exhaust gas is compressed by the electric air compressor 8 into the vehicle-mounted high pressure gas cylinder 7.

Various methods can be used to control the opening and closing of the EGR valve 5. For example, a timing switch mechanism can be designed to open the EGR valve 5 whenever the start or warm-up begins and close the EGR valve 5 after a predetermined period of time. A mechanism controlling the degree of valve opening can be provided to control the opening of the EGR valve 5 according to the actual requirements of the system. In one embodiment, the emission control system further comprises a control device used for controlling the degree of opening of the EGR valve 5.

The foregoing control device can be implemented by using a separate controller and a valve actuator, or by using the original vehicle-mounted controller and valve actuator. In one embodiment, the control device comprises a fuel cell control unit (FCU) 6 and a valve actuator. A timing module can be integrated in the FCU. The FCU issues an instruction for opening the EGR valve 5 when the system starts and warm-up begins, and the valve actuator receives the instruction and uses an electric or pneumatic component to control the EGR valve 5 to be opened to a certain degree, thereby introducing tail gas into the inlet pipe 20 in front of the burner 3. The FCU issues an instruction for closing the EGR valve 5 when the timing module reaches a predetermined time, and the valve actuator receives the instruction and uses an electric or pneumatic component to control the EGR valve 5 to close.

The control device can also cause the FCU to issue instructions for opening and closing the EGR valve 5 according to the actual requirements of the system, thereby achieving an adjustable EGR rate. The EGR rate is defined by the volume flow method. In this case, the EGR rate is defined to be the volume (V₂) of EGR exhaust gas in the volume of the whole burner 3 divided by the sum of the volume (V₁) of inflow fresh air and the volume (V₂) of the EGR exhaust gas in the combustion process, i.e.: EGR rate=V₂/(V₁+V₂)×100%.

The emission control system can further comprise an inlet gas flow detector. The inlet gas flow detector is used for detecting the flow of the inlet gas input from the stack 2 into the inlet pipe 20. The inlet gas flow detector is connected to the fuel cell control unit 6. The inlet gas flow detector reports the inlet gas flow to the FCU, and the FCU calculates the required flow of EGR exhaust gas according to the real-time inlet gas flow and the EGR rate that should be reached, thereby more accurately controlling the degree of opening of the EGR valve 5.

The inlet gas flow detector can be a Venturi flow detector or a flow detector comprising a fan and a temperature and pressure sensor. In one embodiment, the inlet gas flow detector comprises a fan 1 arranged at the gas inlet of the stack 2 and a temperature and pressure sensor arranged at the gas outlet of the stack 2 (second temperature and pressure sensor 14 in FIG. 1). Air is blown by the fan 1 into the stack 2 and then is discharged into the inlet pipe 20 via the gas outlet of the stack 2. Fresh inlet gas is measured based on the rotating speed of the fan 1 and the system temperature and pressure sensor. In this embodiment, a first temperature and pressure sensor 13 is arranged at the gas inlet of the stack 2, as shown in FIG. 1. The first temperature and pressure sensor 13, the second temperature and pressure sensor 14, and the fan 1 are all connected to the FCU. Through calculation of the FCU, the flow of the gas input by the fan 1 can be converted into the flow of the gas behind the stack 2 and can be adjusted based on the values of the first temperature and pressure sensor 13 and the second temperature and pressure sensor 14. The flow of the inlet gas is recorded as V₁.

The flow V₂ of the exhaust gas entering the burner 3 can be controlled by controlling the degree of opening of the EGR valve 5. In this embodiment, the emission control system further comprises an exhaust gas flow detector which is connected to a fuel cell control unit 6. The exhaust gas flow detector reports the exhaust gas flow to the FCU and the FCU can adjust the degree of opening of the EGR valve 5 in real time according to the real-time inlet gas flow and exhaust gas flow, thereby accurately controlling the EGR rate.

In this embodiment, the exhaust gas flow detector is similar to the inlet gas flow detector, and the exhaust gas flow detector can comprise an EGR pressure stabilizing pipe 23 connected between the gas storage device and the EGR valve 5. A temperature and pressure sensor are arranged on the EGR pressure stabilizing pipe 23 (third temperature and pressure sensor 15 in FIG. 1). The EGR pressure stabilizing pipe 23 may be designed to be a composite cavity tube comprising a tube and a cavity, which can have an effect of a pressure stabilizing cavity on the one hand and can store some EGR exhaust gas in advance on the other hand. The volume of the EGR pressure stabilizing pipe 23 is fixed, and the FCU can calculate the equivalent volume in the EGR pressure stabilizing pipe 23 based on the third temperature and pressure sensor 15 (converted into the volume flow of the exhaust gas under the same pressure and temperature conditions as the inlet gas V₂ at the moment).

In one embodiment, the emission control system further comprises a fuel metering unit 18 used for measuring the flow of the fuel input into the burner 3, and a temperature sensor 16, and a nitrogen and oxygen sensor 17 that are connected to the exhaust pipe 21. The fuel gas is input into the burner 3 via the fuel input pipe 19 and is burned together with the inlet gas (as shown by the fine-line arrow in FIG. 1), and the fuel metering unit 18 is arranged on the fuel input pipe 19 and is used for measuring the flow of the input fuel. The temperature sensor 16 can reflect real-time exhaust gas temperature. The nitrogen and oxygen sensor 17 can reflect the level of NOx and other pollutants in the exhaust gas. During the actual operation of the system, the FCU finds the MAP corresponding to the operating condition based on the exhaust temperature of the burner and the feedback value of the nitrogen and oxygen sensor 17 as well as the fuel flow and fan air inflow. After calculation, the real-time degree of opening of the EGR valve 5 is given, the opening time of the vent valve of the high pressure gas cylinder is controlled and finally, the emission of NOx and other pollutants in the exhaust gas is controlled.

In one embodiment, the high pressure gas cylinder 7 is provided with a first vent valve 11, a second vent valve 10, and a one-way valve 12. The high pressure exhaust gas output by the electric air compressor 8 enters the high pressure gas cylinder 7 via the one-way valve 12. The first vent valve 11 is arranged between the high pressure gas cylinder 7 and the EGR valve 5. The first vent valve 11 is used for inputting exhaust gas at certain pressure to the EGR intake pipe and the second vent valve 10 is used for outputting the gas in the high pressure gas cylinder 7 to other gas-using devices of the vehicle. The high pressure gas cylinder 7 is also provided with a pressure relief valve, which ensures the safety of the high pressure gas cylinder 7 when the pressure in the high pressure gas cylinder 7 exceeds a certain value. The thick-line arrow in FIG. 1 denotes the gas flow direction. During the start and warm-up of the system, if the vehicle moves at a certain speed and has the demands such as braking, then for the sake of safety, the high pressure gas cylinder 7 opens the second vent valve 10 with priority for the use of the vehicle braking devices.

After the start and warm-up processes of the system, NOx emission of the system is very low. In this case, the first vent valve 11 is closed and the high pressure gas cylinder 7 directly responds to other pneumatic demands of the vehicle.

The present invention has the following beneficial effects:
1) The EGR rate is adjustable in real time. As high pressure exhaust gas is stored in the high pressure gas cylinder 7 and can be released in real time, the EGR rate is adjustable. Furthermore, after the exhaust gas contacts fresh air, it will be further mixed after entering the burner 3, so when the EGR system works, the exhaust gas and fresh air have been fully mixed;
2) This solution reasonably controls and utilizes the exhaust gas of the system in combination with the resources of the vehicle, can achieve the goal of reducing emissions, can be widely used in fuel cell vehicles or vehicle-mounted power generation systems that have requirements for emissions, and generates huge social and economic benefits;
3) This solution on the one hand can adjust the EGR rate in real time and inhibit the generation of NOx and on the other hand still can use the high pressure gas cylinder as a gas source of the pneumatic devices of the vehicle to complete pneumatic braking.

The present invention further provides a vehicle-mounted solid oxide fuel cell system comprising the foregoing emission control system.

Various modifications to these embodiments will be apparent. The general principle defined herein can be implemented in other embodiments without departing from the spirit or scope of the present invention.

1. An emission control system for a vehicle-mounted solid oxide fuel cell system comprising a stack and a burner, wherein the emission control system comprises:
an EGR intake pipe;
an exhaust cooling device;
a supercharging device;
a gas storage device and an EGR valve connected in sequence by the EGR intake pipe;
wherein an inlet end of the EGR intake pipe is connected to an exhaust pipe of the burner, and an outlet end of the EGR intake pipe is connected to an inlet pipe between the stack and the burner.

2. The emission control system according to claim 1, wherein the emission control system further comprises a control device used for controlling the degree of opening of the EGR valve.

3. The emission control system according to claim 2, wherein the control device comprises a fuel cell control unit and an opening degree actuator.

4. The emission control system according to claim 1, further comprising an inlet gas flow detector connected to the fuel cell control unit for detecting the flow of the inlet gas input from the stack into the inlet pipe.

5. The emission control system according to claim 4, wherein the inlet gas flow detector comprises a fan arranged at a gas inlet of the stack, and a temperature and pressure sensor arranged at a gas outlet of the stack.

6. The emission control system according to claim 1, further comprising an exhaust gas flow detector connected to the fuel cell control unit.

7. The emission control system according to claim 6, wherein the exhaust gas flow detector comprises an EGR pressure stabilizing pipe connected between the gas storage device and the EGR valve, and a temperature and pressure sensor arranged on the EGR pressure stabilizing pipe.

8. The emission control system according to claim 1, further comprising a fuel metering unit for measuring the flow of the fuel input into the burner, and a temperature sensor and a nitrogen and oxygen sensor connected to the exhaust pipe.

9. The emission control system according to claim 1 wherein the gas storage device is a high pressure gas cylinder provided with a first vent valve and a second vent valve, and the first vent valve is arranged between the high pressure gas cylinder and the EGR valve.

10. A vehicle-mounted solid oxide fuel cell system, comprising the emission control system of claim 1.
